(19) United States
(12) Patent Application Publication
(10) Pub. No.: US 2010/0027764 A1
(43) Pub. Date: Feb. 4, 2010

(54) NETWORK DEVICE AND METHOD FOR REDIALING PHONE CALLS

(75) Inventor: JUI-CHANG FU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/329,605

(22) Filed: Dec. 7, 2008

(30) Foreign Application Priority Data
Jul. 31, 2008 (CN) 200810303289.9

(51) Int. Cl. H04M 11/04; H04L 12/66

(52) U.S. Cl. 379/46; 370/352

(57) ABSTRACT

A network device, configured with common and emergency call resources for connecting a telephone terminal to a local exchange, includes a storage module, a control module, and a digital signal processor. The storage module stores a plurality of emergency call numbers. The control module detects a public switched telephone network (PSTN) dialing signal from the telephone terminal and determines if the common call resource has been exhausted upon detecting the PSTN dialing signal. The digital signal processor receives a PSTN call number from the telephone terminal upon the condition that the common call resource has been exhausted, determines if the PSTN call number matches with one of the emergency call numbers, and redials the PSTN call number to the local exchange via the emergency call resource upon the condition that the PSTN call number matches with one of the emergency call numbers.

### BACKGROUND

1. Field of the Invention

Embodiments of the present disclosure relate to network communications, and particularly to a network device and a method for redialing phone calls.

2. Description of Related Art

Generally, an office network device, such as an office gateway, provides call resources without differentiating between common and emergency call resources. For instance, the call resource provided by the office network device may include 128 call channels that are all provided for common users to use. As a result, a 129th user cannot dial a call when the 128 call channels have been occupied by 128 common users.

Moreover, the 129th user cannot dial an emergency number, such as 911, when the 129th user encounters an emergency and the 128 call channels have already been occupied. Therefore, a network device is needed to overcome the aforementioned deficiencies and inadequacies.

### BRIEF DESCRIPTION OF THE DRAWINGS

FIG. 1 is a schematic diagram of an application environment and functional modules of one embodiment of a network device in accordance with the present disclosure; and

FIG. 2 is a flowchart of one embodiment of a method for redialing phone calls in accordance with the present disclosure.

### DETAILED DESCRIPTION OF CERTAIN INVENTIVE EMBODIMENTS

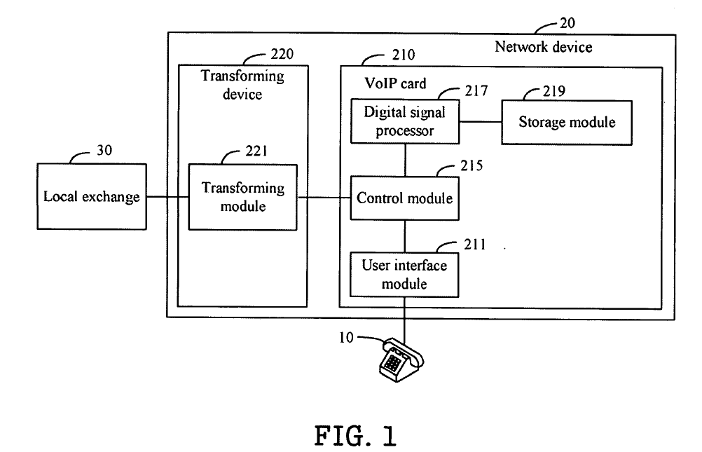

FIG. 1 is a schematic diagram of an application environment and functional modules of one embodiment of a network device 20 in accordance with the present disclosure. In one embodiment, the network device 20 may be an office gateway. The network device 20 connects a plurality of telephone terminals 10 to a local exchange 30, for transmitting public switched telephone network (PSTN) call numbers from the plurality of telephone terminals 10 to the local exchange 30. The network device 20 is configured with common and emergency call resources, which ensures that users are able to dial emergency calls under conditions with limited call resources.

The common and emergency resources respectively include a plurality of call channels. For example, the common and emergency call resources may respectively include 120 and 8 call channels if the network device 20 includes 128 call channels.

In one embodiment, the network device 20 includes a control module 215, a digital signal processor 217, and a storage module 219, which are located in a voice over Internet protocol (VoIP) card 210. The storage module 219 is configured for storing a plurality of emergency call numbers, such as 911. The storage module 219 is also configured for storing other temporary and/or non-temporary data for the network device 20.

In one embodiment, the network device 20 may further include a user interface module 211 connected between the plurality of telephone terminals 10 and the control module 215. The user interface module 211 is configured for transforming first voice signals received from the telephone terminals 10 to first pulse code modulation (PCM) data and transmitting the first PCM data to the control module 215. The user interface module 211 is also configured for transforming second PCM data received from the control module 215 to second voice signals, subsequently transmitting the second voice signals to the telephone terminals 10. In one embodiment, the user interface module 211 may be a subscriber line interface circuit (SLIC).

The control module 215 is connected to the user interface module 211 for detecting a PSTN dialing signal, namely a dual tone multiple frequency (DTMF) signal, derived from one telephone terminal 10 via the user interface module 211, and determining if the common call resource has been exhausted upon detecting the PSTN dialing signal. In one embodiment, the control module 215 determines if all call channels of the common call resource have been used. The control module 215 determines that the common call resource has been exhausted if all call channels of the common call resource have been used, and determines that the common call resource has not been exhausted if at least one call channel of the common call resource has not been used.

The digital signal processor 217 receives a PSTN call number from the telephone terminal 10 via the user interface module 211 and the control module 215 upon the condition that the common call resource has been exhausted. The digital signal processor 217 then determines if the PSTN call number matches with one of the emergency call numbers, and redials the PSTN call number to the local exchange 30 via the emergency call resource upon the condition that the PSTN call number matches with one of the emergency call numbers. In one embodiment, the digital signal processor 217 compares the PSTN call number with each emergency call number to determine if the PSTN call number matches with one of the emergency call numbers.

The control module 215 is further configured for connecting the user interface module 211 to the digital signal processor 217 upon the condition that the common call resource has been exhausted, and for connecting the user interface module 211 to the local exchange 30 upon the condition that the common call resource has not been exhausted. The control module 215 is further configured for connecting the digital signal processor 217 to the local exchange 30 upon the condition that the PSTN call number matches with one of the emergency call numbers, and for connecting the digital signal processor 217 to the user interface module 211 upon the condition that the PSTN call number does not match with one of the emergency call numbers. In one embodiment, the control module 215 may be a time slot interchange (TSI).

In one example of the present disclosure, a user may use the telephone terminal 10 to dial a PSTN call number, and subsequently the control module 215 detects a PSTN dialing signal derived from the telephone terminal 10 via the user interface module 211 and determines if the common call resource has been exhausted.

If the common call resource has not been exhausted, the control module 215 connects the user interface module 211 to the local exchange 30, receives the PSTN call number from the telephone terminal 10 via the user interface module 211, and transmits the PSTN call number to the local exchange 30 via the common call resource.

If the common call resource has been exhausted, the control module 215 connects the user interface module 211 to the digital signal processor 217. In such a case, the digital signal processor 217 receives the PSTN call number from the telephone terminal 10 via the user interface module 211 and the control module 215, and determines if the PSTN call number matches with one of the emergency call numbers. If the PSTN call number does not match with any of the emergency call numbers, the digital signal processor 217 plays a busy tone to the telephone terminal 10 via the control module 215 and the user interface module 211.

If the PSTN call number matches with one of the emergency call numbers, the control module 215 connects the digital signal processor 217 to the local exchange 30. Afterwards, the digital signal processor 217 redials the PSTN call number to the local exchange 30 via the emergency call resource.

In another example of the present disclosure, a user may use the telephone terminal 10 to dial a voice over Internet protocol (VoIP) call number, and subsequently the control module 215 detects a VoIP dialing signal from the telephone terminal 10 via the user interface module 211. The control module 215 connects the user interface module 211 to the digital signal processor 217 when the VoIP dialing signal has been detected. The digital signal processor 217 further receives the VoIP call number from the telephone terminal 10 via the user interface module 211 and the control module 215, and transmits the VoIP call number to the Internet.

Preferably, the network device 20 may further include a transforming module 221 connected between the control module 215 and the local exchange 30. The transforming module 221 is configured for transforming the first PCM data received from the control module 215 to first E1 signals, transmitting the first E1 signals to the local exchange 30. The transforming module 221 is also configured for transforming second E1 signals received from the local exchange 30 to the second PCM data, and transmitting the second PCM data to the control module 215. It may be understood that E1 signals are the European format for digital signal transmission. The transforming module 221 may be located in a transforming device 220. The transforming device 220 and the transforming module 221 may be a time division multiplexing switch and a time slot interchange, respectively.

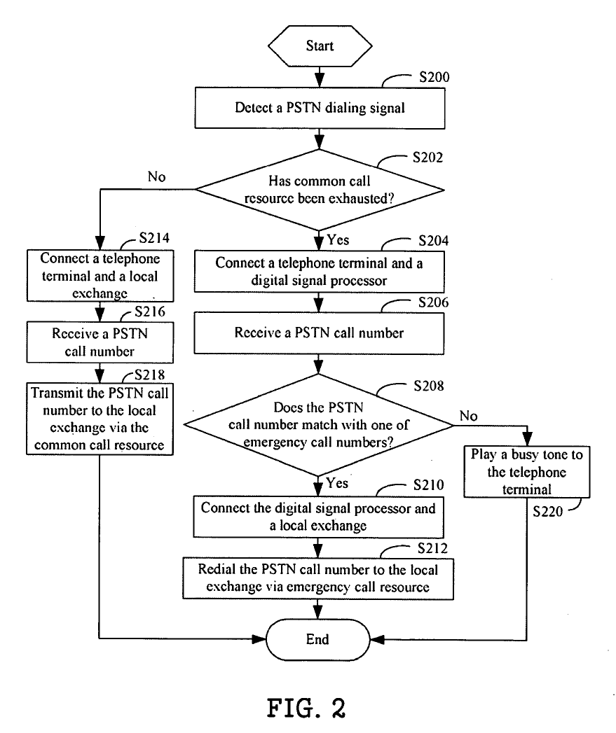

FIG. 2 is a flowchart of one embodiment of a method for redialing phone calls in accordance with the present disclosure. The method is executed by the functional modules of FIG. 1. Depending on the embodiment, the method of FIG. 2 may comprise more or less blocks and the ordering of the blocks may be changed.

In block S200, the control module 215 detects a PSTN dialing signal derived from the telephone terminal 10. As mentioned above, a user may use the telephone terminal 10 to dial a PSTN call number, and subsequently the control module 215 detects a PSTN dialing signal from the telephone terminal 10 via the user interface module 211.

In block S202, the control module 215 determines if common call resource has been exhausted upon detecting the PSTN dialing signal. In one embodiment, the control module 215 determines if all call channels of the common call resource have been used. The control module 215 determines that the common call resource has been exhausted if all call channels of the common call resource have been used, and determines that the common call resource has not been exhausted if at least one call channel of the common call resource has not been used.

If the common call resource has not been exhausted, in block S214, the control module 215 connects the telephone terminal 10 to the local exchange 30.

In block S216, the control module 215 receives a PSTN call number from the telephone terminal 10 via the user interface module 211.

In block S218, the control module 215 transmits the PSTN call number to the local exchange 30 via the common call resource.

If the common call resource has been exhausted, in block S204, the control module 215 connects the telephone terminal 10 to the digital signal processor 217 via the user interface module 211.

In block S206, the digital signal processor 217 receives a PSTN call number from the telephone terminal 10 via the user interface module 211 and the control module 215.

In block S208, the digital signal processor 217 determines if the PSTN call number matches with one of the emergency call numbers. In one embodiment, the digital signal processor 217 compares the PSTN call number with each emergency call number to determine if the PSTN call number matches with one of the emergency call numbers.

If the PSTN call number does not match with any of the emergency call numbers, in block S220, the digital signal processor 217 plays a busy tone to the telephone terminal 10 via the control module 215 and the user interface module 211.

If the PSTN call number matches with one of the emergency call numbers, in block S210, the control module 215 connects the digital signal processor 217 to the local exchange 30.

In block S212, the digital signal processor 217 redials the PSTN call number to the local exchange 30 via the emergency call resource.

Thus, the network device 20 of the present disclosure differentiates between the common call resource and the emergency call resource, and redials the PSTN call number to the local exchange 30 by the digital signal processor 217, which ensures that users are able to dial emergency calls under conditions with limited call resources.

While various embodiments and methods of the present disclosure have been described above, it should be understood that they have been presented by way of example only and not by way of limitation. Thus, the breadth and scope of the present disclosure should not be limited by the above-described embodiments, but should be defined only in accordance with the following claims and their equivalents.

What is claimed is:

1. A network device configured with common and emergency call resources for connecting a telephone terminal to a local exchange, the network device comprising:
a storage module configured for storing a plurality of emergency call numbers;
a control module configured for detecting a public switched telephone network (PSTN) dialing signal derived from the telephone terminal, and for determining if the common call resource has been exhausted upon detecting the PSTN dialing signal, wherein the common call resource has been exhausted if all call channels of the common call resource have been used, and wherein the common call resource has not been exhausted if at least one call channel of the common call resource has not been used; and
a digital signal processor configured for receiving a PSTN call number from the telephone terminal upon the condition that the common call resource has been exhausted, determining if the PSTN call number matches with one of the emergency call numbers, and redialing the PSTN call number to the local exchange via the emergency call resource upon the condition that the PSTN call number matches with one of the emergency call numbers;
wherein the control module is further configured for connecting the telephone terminal to the digital signal processor upon the condition that the common call resource has been exhausted, and for connecting the digital signal processor to the local exchange upon the condition that the PSTN call number matches with one of the emergency call numbers.

2. The network device of claim 1, wherein the common call resource and the emergency call resource respectively comprise a plurality of call channels.

3. The network device of claim 1, wherein the control module is further configured for connecting the telephone terminal to the local exchange upon the condition that the common call resource has not been exhausted, receiving a PSTN call number from the telephone terminal, and transmitting the PSTN call number to the local exchange via the common call resource.

4. The network device of claim 1, wherein the digital signal processor is further configured for playing a busy tone to the telephone terminal via the control module upon the condition that the PSTN call number does not match with any of the emergency call numbers.

5. The network device of claim 1, wherein:
the control module is further configured for detecting a voice over Internet protocol (VoIP) dialing signal from the telephone terminal, and connecting the telephone terminal to
the digital signal processor upon detecting the VoIP dialing signal; the digital signal processor is further configured for receiving a VoIP call number from the telephone terminal via the control module, and for transmitting the VoIP call number to the Internet.

6. The network device of claim 1, further comprising a user interface module connected between the telephone terminal and the control module for transforming first voice signals received from the telephone terminal to first pulse code modulation (PCM) data and sending the first PCM data to the control module, and for transforming second PCM data received from the control module to second voice signals and transmitting the second voice signals to the telephone terminal.

7. The network device of claim 6, further comprising a transforming module connected between the control module and the local exchange for transforming the first PCM data received from the control module to first E1 signals and transmitting the first E1 signals to the local exchange, and for transforming second E1 signals received from the local exchange to the second PCM data and transmitting the second PCM data to the control module.

8. A method for redialing phone calls applied in a network device, the network device being configured with common and emergency call resources for connecting a telephone terminal to a local exchange, the method for redialing phone calls comprising:
providing a digital signal processor and a plurality of emergency call numbers;
detecting a public switched telephone network (PSTN) dialing signal derived from the telephone terminal;
determining if the common call resource has been exhausted upon detecting the PSTN dialing signal, wherein the common call resource has been exhausted if all call channels of the common call resource have been used, and wherein the common call resource has not been exhausted if at least one call channel of the common call resource has not been used;
connecting the telephone terminal to the digital signal processor if the common call resource has been exhausted;
receiving a PSTN call number from the telephone terminal by the digital signal processor;
determining if the PSTN call number matches with one of the emergency call numbers by the digital signal processor;
connecting the digital signal processor to the local exchange if the PSTN call number matches with one of the emergency call numbers; and
redialing the PSTN call number to the local exchange via the emergency call resource by the digital signal processor.

9. The method of claim 8, wherein the common call resource and the emergency call resource respectively comprise a plurality of call channels.

10. The method of claim 8, further comprising:
connecting the telephone terminal to the local exchange if the common call resource has not been exhausted;
receiving a PSTN call number from the telephone terminal; and
transmitting the PSTN call number to the local exchange via the common call resource.

11. The method of claim 8, further comprising:
playing a busy tone to the telephone terminal if the PSTN call number does not match with any of the emergency call numbers.
